(19) United States
(12) Patent Application Publication
(10) Pub. No.: US 2006/0168038 A1
(43) Pub. Date: Jul. 27, 2006

(54) Message gateways and methods and systems for message dispatching based on group communication

(75) Inventor: Jyun-Naih Lin, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Institute for Information Industry

(21) Appl. No.: 11/028,004

(22) Filed: Jan. 3, 2005

(30) Foreign Application Priority Data
Nov. 18, 2004 (TW) 93135375

(51) Int. Cl. G06F 15/16

(52) U.S. Cl. 709/206

(57) ABSTRACT

A system for message dispatching based on group communication. The system comprises a message gateway, receiving a message from a message server, retrieving a header and contents of the message corresponding to a message address, determining whether first field information in the header contents is identical to a group name in the group address book. If so, the priority in a second field information in the header contents is verified, and the message is sent to each recipient in a group according to reception address information and presence states corresponding to the priority using different data reception methods.

### BACKGROUND

The invention relates to message dispatching methods, and more particularly, to methods for message dispatching based on group communication.

FIG. 1 is a schematic view of an electronic mail (email) delivery procedure.

Sender 110 comprises mail user agent (MUA) 1 and mail transport agent (MTA) 1 for sending emails. Recipient 130 comprises mail user agent (MUA) 2 and mail transport agent (MTA) 2 for receiving emails. The MUA and MTA implement email sending and receiving processes thereby according to Simple Mail Transport Protocol (SMTP) and Post Office Protocol version 3 (POP3) (or Internet Message Access Protocol version 4 (IMAP4)).

MUA1 of sender 110 translates and sends input content comprising text, images, music, or videos, to an email complying with Internet email standards to MTA1. MTA1 of sender 110 receives and sends the email to MTA2 of recipient 130, and MUA2 of sender 110 retrieves the email from MTA2. In the described delivery procedure between MUA1 and MTA1 of sender 110 and MTA2 and MUA2 of recipient 130, emails are sent and received according to SMTP and retrieved according to POP3 or IMAP4.

Generally, a complete email address is required for a delivery procedure. An email address is represented as “user_account@MailServer_Name”, such as aaa@bbb.ccc (as shown in FIG. 2), where “aaa” is a user account and “bbb.ccc” is a mail server name. A group title (indicating an email list) can also be input to send an email to multiple recipients in previously defined and stored in an email address book. Referring to FIG. 3, a group entitled “friends” in which email addresses “aaa@bbb.ccc” and “ddd@bbb.ccc” are included has been created in an email address book. The group “friends” is input in a recipient field of an email to be sent and the email can be sent to recipients “aaa” and “ddd”.

Emails can be edited and sent through an email client such as Outlook or Outlook Express by Microsoft Co. as shown in FIGS. 2 and 3, or via a webmail service as shown in FIG. 4. Current email systems, however, still have some drawbacks regarding email delivery processes.

Normally, multiple recipients are defined in a group, for convenience, and emails are sent to those recipients only when the group is input in a recipient field of an email message. Email groups can be created using any of the following methods. One method is to create a group address book comprising multiple group titles by a user at the client-side and the other is to create email alias lists at the server-side by an administrator. In the former method, the address book can be only located on a specific personal computer and the latter method is inconvenient for users.

Additionally, emails at the sender-end can only be sent to the email receiver-end via the server-side list and users at the receiver-end may miss significant messages if they do not activate an email client or connect to a webmail service to retrieve their messages.

Thus, a method for message dispatching based on group communication is desirable.

### SUMMARY

A message gateway is provided. An embodiment of such a message gateway comprises at least one data allocating module, email retrieving module, data processing module, and data forwarding module. The data allocating module creates a group address book, comprising at least one first group corresponding to a first message address and comprising at least one recipient, wherein the recipient is assigned with a plurality of data reception methods and reception address information corresponding to each data reception method. The email retrieving module retrieves a mail header and mail contents of a message corresponding to the first message address. The data processing module determines whether first field information in the mail header is identical to the first group name in the group address book, and, if so, the message is sent according to second field information in the mail header. The data forwarding module retrieves the message from the data processing module and sends the message to the recipient according to a data reception method corresponding to the second field information and a presence state and reception address information corresponding to the data reception method.

Also disclosed are systems for message dispatching based on group communication. An embodiment of such a system comprises at least a personal computer, a message server, and a message gateway. The personal computer sends a message to the message server and creates a group address book in the message gateway, comprising at least one first group corresponding to a first message address and comprising at least one recipient. The recipient is assigned a plurality of data reception methods and reception address information corresponding to each data reception method. The message server receives the message. The message gateway retrieves a header and contents of the message corresponding to the first message address, determines whether first field information in the header is identical to the first group name in the group address book, and, if so, sends the message to the recipient according to a data reception method corresponding to the second field information in the header and a presence state and reception address information corresponding to the data reception method.

Further disclosed are methods for message dispatching based on group communication. In an embodiment of such a method, a group address book, comprising at least one first group corresponding to a first message address and comprising at least one recipient, is created. The recipient is assigned with a plurality of data reception methods and reception address information corresponding to each data reception method. A message sent and a header and contents of the message corresponding to the first message address is retrieved. It is determined whether first field information in the header is identical to the first group name in the group address book. If so, the message is sent to the recipient according to a data reception method corresponding to the second field information in the header and a presence state and reception address information corresponding to the data reception method.

### BRIEF DESCRIPTION OF THE DRAWINGS

Systems and methods for message dispatching based on group communication can be more fully understood by reading the subsequent detailed description and examples of embodiments thereof with reference made to the accompanying drawings, wherein:

FIG. 1 is a schematic view of an email delivery procedure;

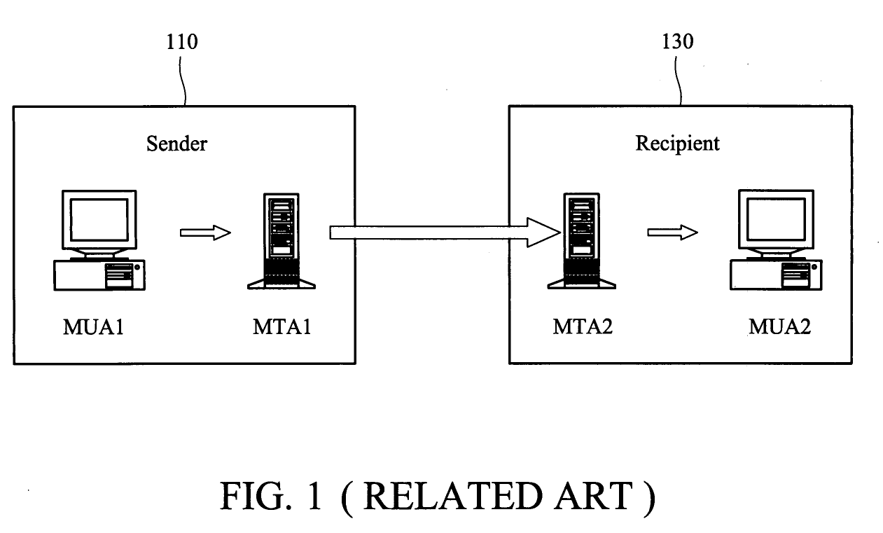

FIG. 2 is a schematic view of a GUI of an email delivery procedure using an email client;

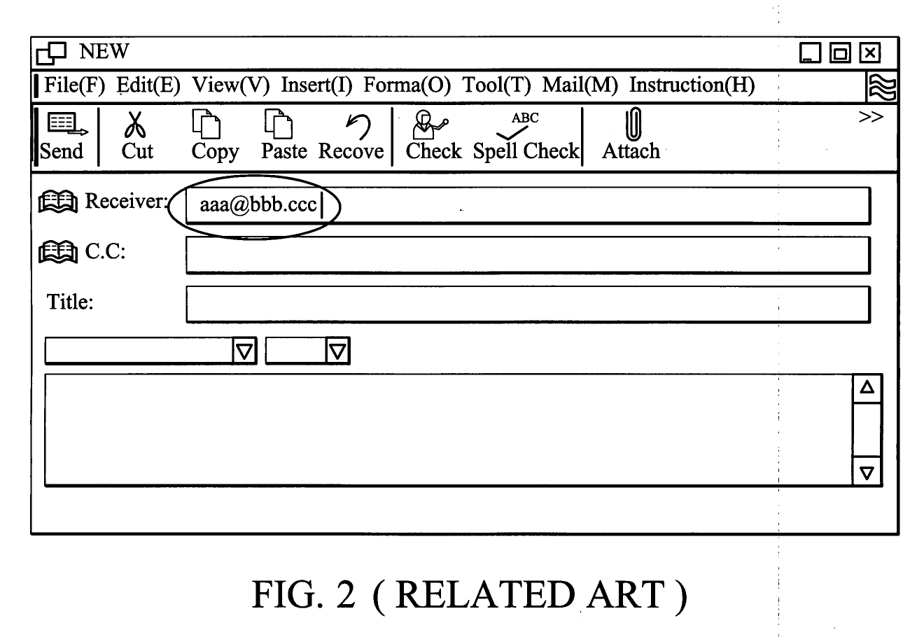

FIG. 3 is a schematic view of a GUI of an email group delivery procedure using an email client;

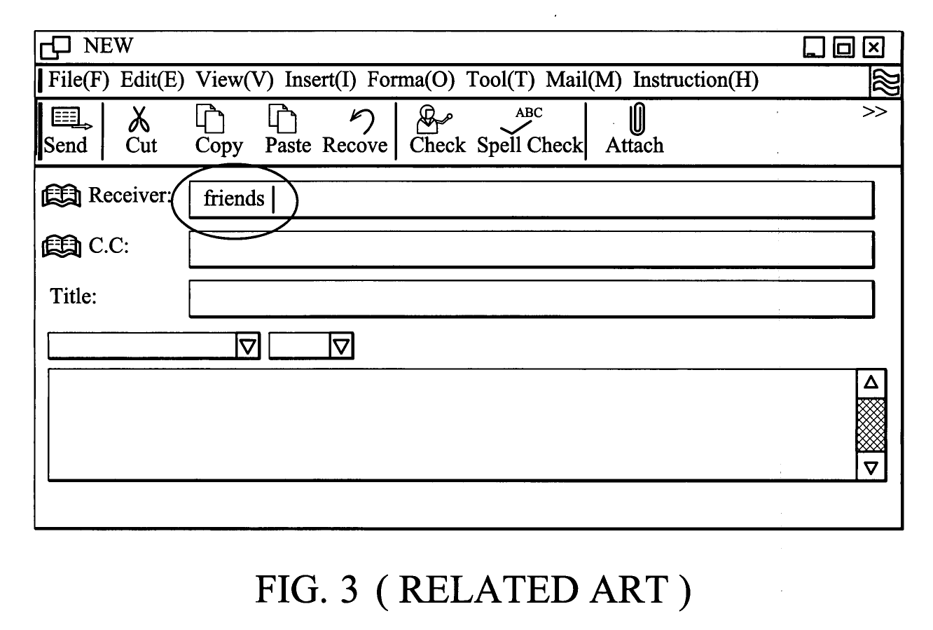

FIG. 4 is a schematic view of a GUI of an email delivery procedure using a webmail service;

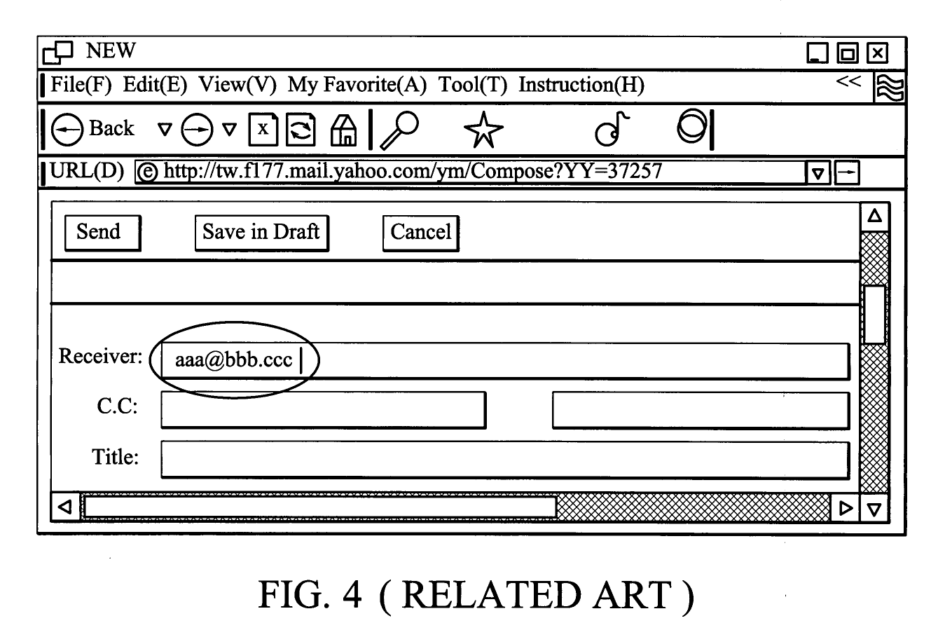

FIG. 5 is a schematic view of an embodiment of a system for message dispatching based on group communication of the invention;

FIG. 6 is a schematic view of an embodiment of a group address book of the invention;

FIG. 7 is a schematic view of an embodiment of a GUI of an email group delivery procedure using an email client of the invention;

FIG. 8 is a schematic view of an embodiment of a GUI of an email group delivery procedure using a webmail service of the invention;

FIG. 9 is a schematic view of the header contents of an email;

FIG. 10 is a schematic view of an embodiment of a message gateway of the invention;

FIG. 11 is a schematic view of an embodiment of a data forwarding module of the invention; and

FIG. 12 is a flowchart of an embodiment of a method for message dispatching based on group communication of the invention.

### DETAILED DESCRIPTION

Embodiments of the invention disclose a message gateway and a system and method for message dispatching based on group communication.

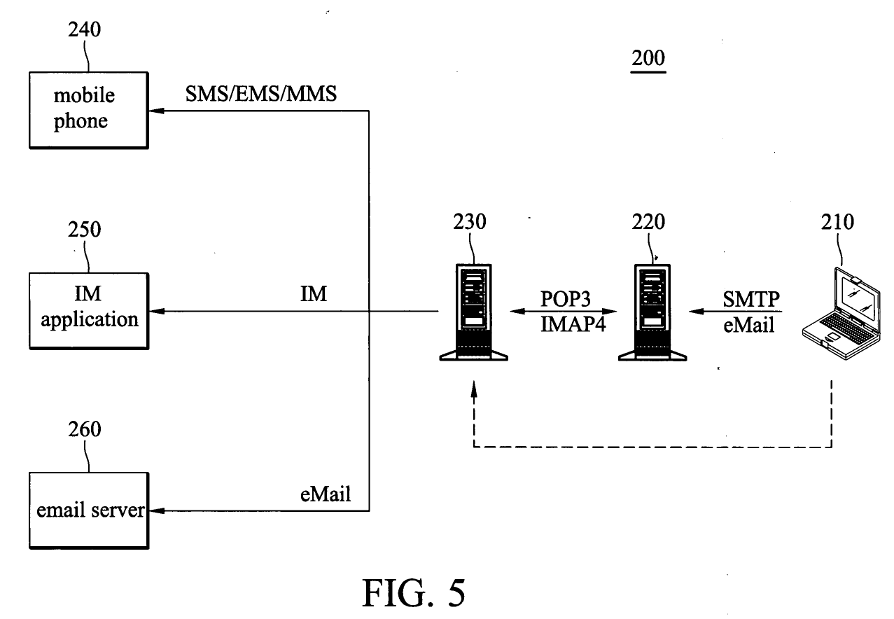

FIG. 5 is a schematic view of an embodiment of a system for message dispatching based on group communication of the invention. Message dispatching system 200 comprises a personal computer 210, an email server 220, and a message gateway 230. Personal computer 210 sends an email to email server 220 and message gateway 230 retrieves the email from email server 220 for email delivery processing, forwarding the email to a mobile phone 240, an instant message (IM) application 250, or an email server 260. as described above, email sending and receiving processes between personal computer 210, email server 220, and message gateway 230 are implemented according to SMTP and POP3 (or IMAP4), and description thereof is omitted in the following for simplicity.

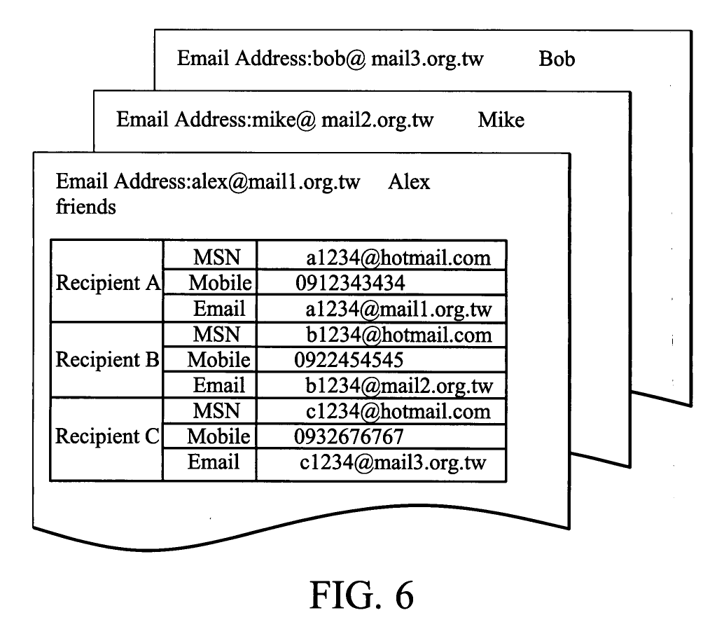

Users connect to message gateway 230 using personal computer 210 via the Internet, then login through a web page service and create individual email addresses and group address books. A user, Alex, for example, creates his email address “alex@mail1.org.tw” and an email group entitled “friends” in his group address book. Referring to FIG. 6, message gateway 230 comprises email addresses and groups created by users Alex, Bob, and Mike. The email group created by Alex can also be shown in table 1, comprising recipients A, B, and C, each is assigned with three receiving methods, such that messages can be sent to recipients via instant message using the MSN instant message service, mobile messages (by short message service (SMS)/enhanced message service (EMS)/multimedia message service (MMS)), or emails.

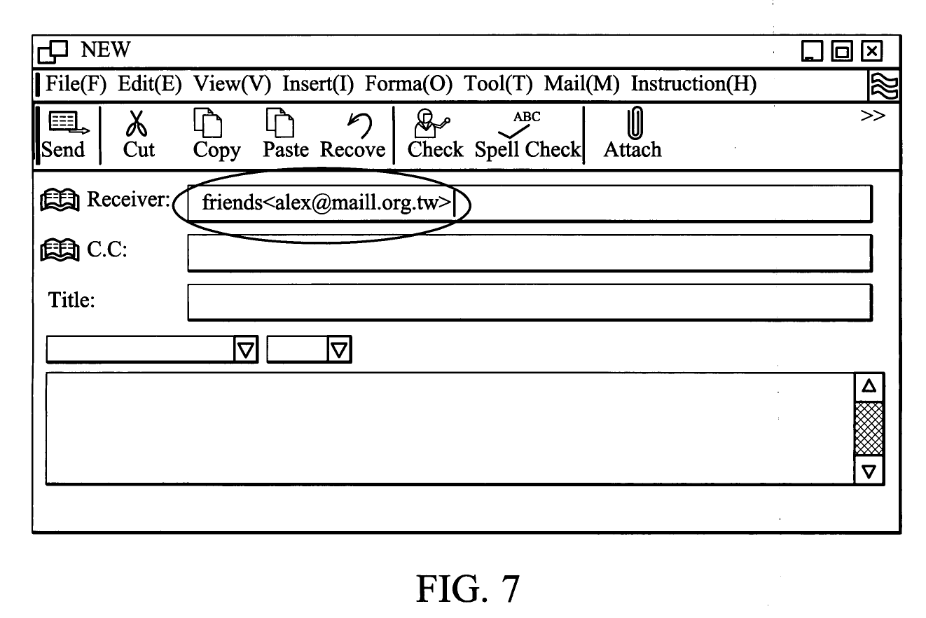

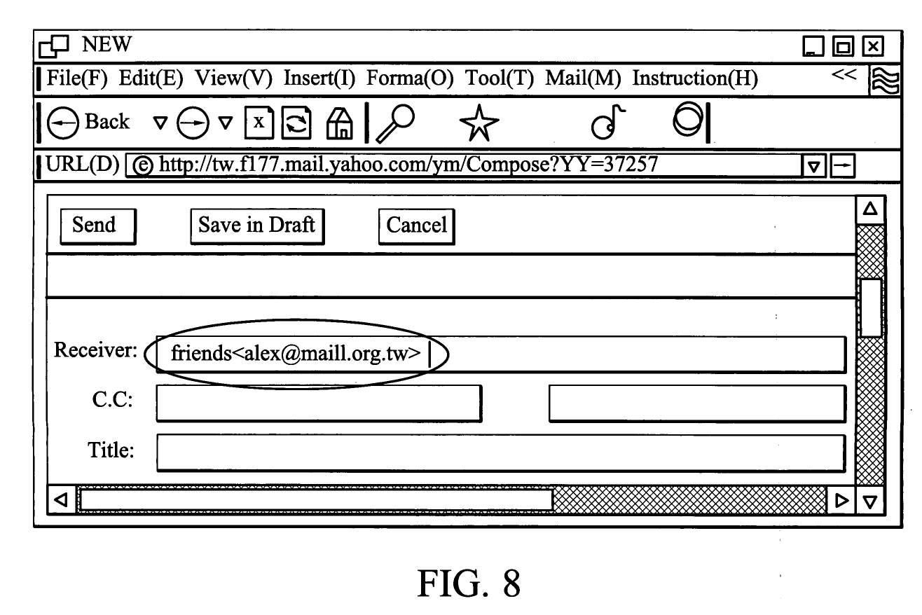

To solve drawbacks caused by conventional email communication systems, embodiments of the invention inputs “group_name<user_account@MailServer_Name>” in a recipient field, where the “group name” is the name of an email group stored in a group address book of the user in message gateway 230, “user_account@MailServer_Name” is an email address registered in message gateway 230 for delivery verification and referenced to retrieve messages from the email address for processing. If a message, for example, is going to be sent by Alex, to recipients in the group “friends”, “friends<alex@mail1.org.tw>” is input in a recipient field of an email message using an email client (shown in FIG. 7) or a webmail service (shown in FIG. 8), where “friends” is the group to send and alex@mail1.org.tw is an email address created by the user Alex, details of which are further described in the following.

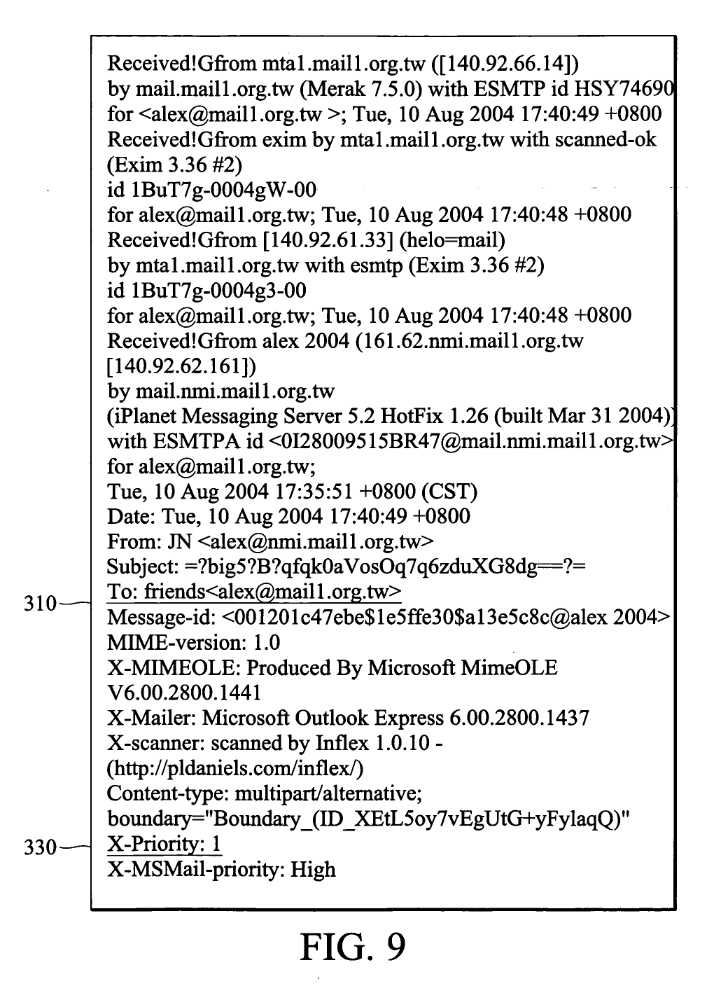

As described above, an email is sent, by Alex, through personal computer 210, translated to an email complying with Internet email standards, contents of email header thereof shown in FIG. 9. Header information 310 indicates recipients of the email and header information 330 indicates the priority of the email, i.e. the priority of the email. An email is assigned an “X-priority” wherein 1 indicates the highest priority, 3, indicates normal, and 5, indicates low priority. In this embodiment of the invention, the “X-priority” value is 1, the highest priority.

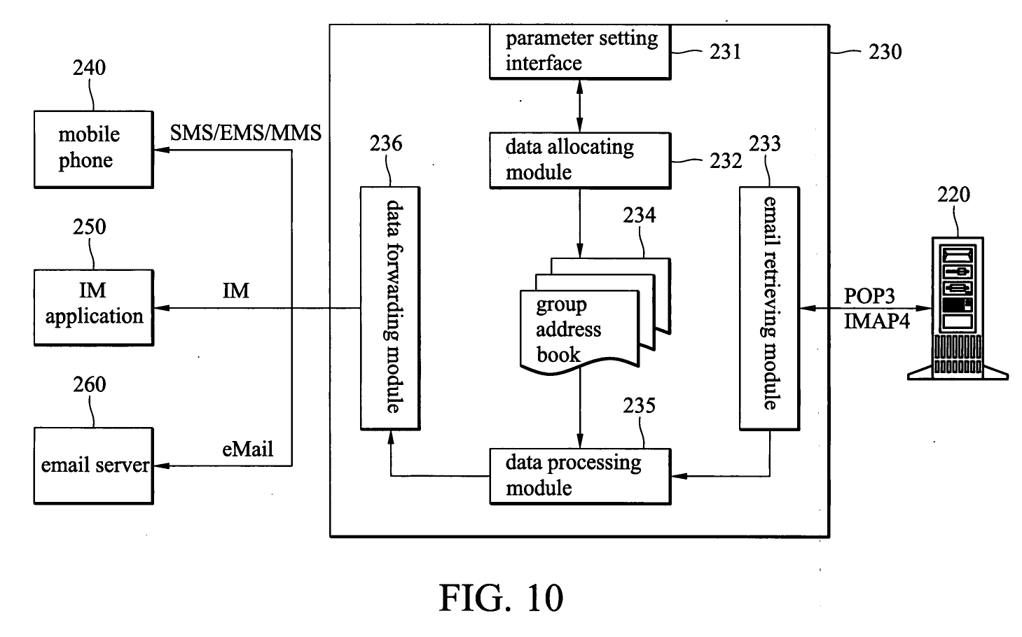

The translated email is sent to email server 220, “mail1.org.tw” in this embodiment. Email server 220 receives and stores the email in a recipient (Alex) mailbox. Message gateway 230 checks whether email server 220 has received emails by time intervals. Referring to FIG. 10, a schematic view of an embodiment of message gateway 230, comprising a parameter setting interface 231, a data allocating module 232, an email retrieving module 233, a group address book 234, a data processing module 235, and a data forwarding module 236.

As described above, the user Alex connects to message gateway 230 through parameter setting interface 231 and creates an individual email address (alex@mail1.org.tw) and a group address book 234. Email retrieving module 233 retrieves a header and contents of the email through POP3/IMAP4 communication protocol and data processing module 235 checks recipient field information 310 (To: friends<alex@mail1.org.tw>) and priority field information 330 (X-Priority:1) included in the email header, such that message gateway 230 recognizes that the email should be forwarded to recipients A, B, and C in the “friends” group of the user Alex with the priority of the email being “highest priority”.

Data processing module 235 determines whether a “friends” group exists in group address book 234 created by the user Alex. If so, data processing module 235 retrieves the email using email retrieving module 233, transfers it to data forwarding module 236 while sending a message to inform data forwarding module 236 of translating the email to an instant message, a short message, or an email, and forwards it to instant message applications, mobile phones, or email servers of recipients A, B, and C in the “friends” group.

As described above, embodiments of the invention send an email to mobile phone 240, instant message application 250, or email server 260. Data forwarding module 236 of message gateway 230 forwards data, if a desired recipient is on-line with his instant message application activated, disregarding the priority of the email, the email to the instant message application of the desired recipient with an instant message. If the desired recipient is off-line with the instant message application inactivated and the priority of the email is “highest priority”, data forwarding module 236 forwards the email to the mobile phone of the desired recipient with a short message service. If the desired recipient is off-line with his instant message application inactivated and the priority of the email is “normal or low priority”, data forwarding module 236 forwards the email to the email server of the desired recipient.

In the described embodiment of the invention, the value of “X-Priority” of the email is 1, thus indicating “highest priority”. If recipients A, B, or C are on-line with their instant message applications activated, the email is forwarded to them with instant messages respectively, and if not, with short messages respectively.

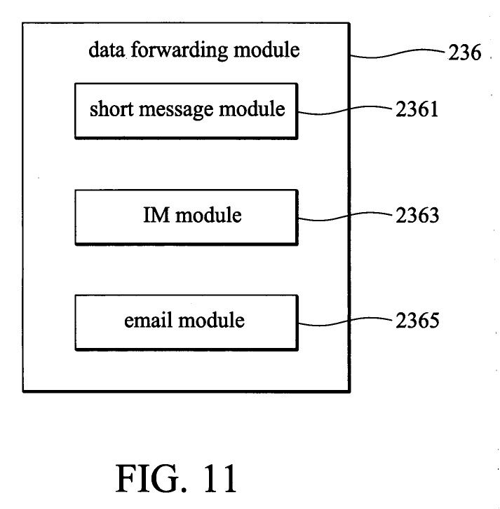

Next, data forwarding module 236 receives the message from data processing module 235 and translates the email to a short message accessible by mobile phone 240 or an accessible format instant message by instant message application 250 or maintain its format for forwarding to recipients A, B, and C. Referring to FIG. 11, data forwarding module 236 comprises a short message module 2361, an instant message module 2363, and an email module 2365, using one of those modules to translate the email, according to the priority thereof, to a desired format message and forwarding the translated message to mobile phone 240, instant message application 250, or email server 260. Receiving methods described in this embodiment of the invention are not limited to the above three receiving methods and description thereof is not intended to limit the invention thereto. Additionally, when a receiving method corresponding to a priority value of a mobile phone does not exist, the email is forwarded using another receiving method.

Further, embodiments of invention are not limited to translate an email to an instant message or a short message. The email can also be translated to an other desired data format for forwarding to mobile phones, instant message applications, email servers, or other communication devices or applications.

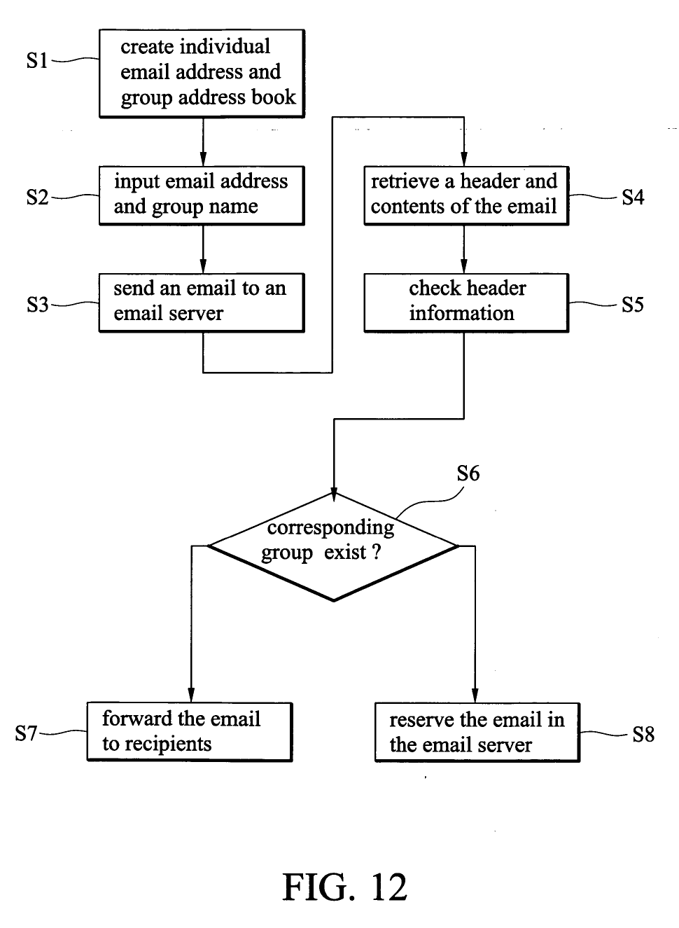

FIG. 12 is a flowchart of an embodiment of a method for message dispatching based on group communication of the invention.

An individual email address and group address book is first created in a message gateway (step S1). The email address and a group name of a desired group in the group address book is input in a recipient field provided by an email application and a priority of the email is assigned (step S2). An email with the email address and group name is sent to an email server (step S3). A message gateway retrieves a header and contents of the email (step S4) and checks information recorded in the header with contents of the group address book (step S5), determining whether a corresponding group has been created (step S6). If so, the message gateway retrieves the email from the email server, and forwards the email to mobile phones, instant message applications, or email servers of recipients in the group (step S7). If not, the email is regarded as a normal email and then reserved in the email server without retrieving by the message gateway (step S8).

Embodiments of the invention enable individual group address book creation in a message gateway instead of a personal computer by email applications or an email server by administrators. Emails (messages) can be sent to recipients in a predefined email group using email service systems, comprising general email applications, webmail service systems, and mobile phones capable of sending emails. Additionally, embodiments of the invention enable different users to create the same group name in a message gateway. As described above, for example, the user Alex create an email group “friend” corresponding to his email address, and the user Mike can also create an email group “friend” corresponding to his email address. Thus, multiple email groups, corresponding to different users and email addresses, with the same group name can reside in the message gateway simultaneously. Further, embodiments of the invention enable message dispatching through any communication device or application and automatically select for an instant message, a mobile short message, or an email to forward a message or an email to recipients.

Embodiments of the invention describe email dispatching for email communication systems but are not intended to limit the invention. The invention can also be applied to mobile message dispatching for mobile communication systems that utilizes different communication protocols and data formats from the described above.

Although the present invention has been described in preferred embodiments, it is not intended to limit the invention thereto. Those who are skilled in this technology can still make various alterations and modifications without departing from the scope and spirit of this invention. Therefore, the scope of the present invention shall be defined and protected by the following claims and their equivalents.

What is claimed is:

1. A message gateway, comprising:
a data allocating module, creating a group address book, comprising at least one first group corresponding to a first message address and comprising at least one recipient, wherein the recipient is assigned with a plurality of data reception methods and reception address information corresponding to each data reception method;
an email retrieving module, retrieving a header and contents of a message corresponding to the first message address;
a data processing module, coupled to the data allocating module and email retrieving module, determining whether first field information in the header contents is identical to the first group name in the group address book, if so, the message is sent according to a second field information in the header contents; and
a data forwarding module, coupled to the data processing module, retrieving the message from the data processing module and sending the message to the recipient according to a data reception method corresponding to the second field information and a presence state and reception address information corresponding to the data reception method.

2. The message gateway as claimed in claim 1, wherein contents of a recipient field in the message comprises the first group name and the first message address.

3. The message gateway as claimed in claim 1, wherein the recipient is assigned with at least one first, second, and third data reception methods, and at least one first, second, and third reception address information, the data forwarding module comprises at least one first, second, and third translating module, each corresponding to the first, second, and third data reception methods respectively, the data processing module sends the message to the first translating module according to the second field information, and the first translating module sends the message to the recipient according to the first data reception method and the first reception address information.

4. The message gateway as claimed in claim 1, wherein the group address book of another user further comprises a second group, a name thereof is identical to the name of the first group, the second group corresponds to a second message address and comprises at least one recipient, and the recipient is assigned with a plurality of data reception methods and reception address information corresponding to each data reception method.

5. A system for message dispatching based on group communication, comprising:
a personal computer, sending a message and creating a group address book, comprising at least one first group corresponding to a first message address and comprising at least one recipient, wherein the recipient is assigned with a plurality of data reception methods and reception address information corresponding to each data reception method;
a message server, coupled to the personal computer, receiving the message; and
a message gateway, coupled to the personal computer and the message server, retrieving a header and contents of the message corresponding to the first message address, determining whether first field information in the header contents is identical to the first group name in the group address book, and, if so, sending the message to the recipient according to a data reception method corresponding to the second field information and a presence state and reception address information corresponding to the data reception method.

6. The system for message dispatching as claimed in claim 5, wherein contents of a recipient field in the message comprises the first group name and the first message address.

7. The system for message dispatching as claimed in claim 5, wherein the recipient is assigned with at least one first, second, and third data reception methods, and at least one first, second, and third reception address information, the message gateway comprises at least one first, second, and third translating module, each corresponding to the first, second, and third data reception methods respectively, and sends the message to the first translating module according to the second field information, and the first translating module sends the message to the recipient according to the first data reception method and the first reception address information.

8. The system for message dispatching as claimed in claim 5, wherein the group address book further comprises a second group of another user, a name thereof is identical to the name of the first group, the second group corresponds to a second message address and comprises at least one recipient, and the recipient is assigned with a plurality of data reception methods and reception address information corresponding to each data reception method.

9. A method for message dispatching based on group communication, comprising:
creating a group address book, comprising at least-one first group corresponding to a first message address and comprising at least one recipient, wherein the recipient is assigned with a plurality of data reception methods and reception address information corresponding to each data reception method;
sending a message;
retrieving a header and contents of the message corresponding to the first message address;
determining whether first field information in the header contents is identical to the first group name in the group address book; and
if the first field information is identical to the first group name, sending the message to the recipient according to a data reception method corresponding to the second field information and a presence state and reception address information corresponding to the data reception method.

10. The method for message dispatching as claimed in claim 9, wherein contents of a recipient field in the message comprises the first group name and the first message address.

11. The method for message dispatching as claimed in claim 9, further comprising:
assigning the recipient with at least one first, second, and third data reception methods, and at least one first, second, and third reception address information;
retrieving the message through a message gateway, comprises at least one first, second, and third translating module, each corresponding to the first, second, and third data reception methods respectively;
sending the message to the first translating module according to the second field information; and
the first translating module sending the message to the recipient according to the first data reception method and the first reception address information.

12. The method for message dispatching as claimed in claim 9, wherein the group address book further comprises a second group of another user, a name thereof is identical to the name of the first group, the second group corresponds to a second message address and comprises at least one recipient, and the recipient is assigned with a plurality of data reception methods and reception address information corresponding to each data reception method.
